(19) United States
(12) Patent Application Publication
(10) Pub. No.: US 2014/0265342 A1
(43) Pub. Date: Sep. 18, 2014

(54) EVAPORATIVE COOLING SYSTEM COMPRISING ENERGY RECOVERY TURBINE(S)

(71) Applicant: TEMPEST ENVIRONMENTAL SYSTEMS, INC., Durham, NC (US)

(72) Inventor: Gerard F. Tempest, JR., Chapel Hill, NC (US)

(73) Assignee: TEMPEST ENVIRONMENTAL SYSTEMS, INC., Durham, NC (US)

(21) Appl. No.: 13/835,010

(22) Filed: Mar. 15, 2013

(51) Int. Cl. F03B 13/10

(52) U.S. Cl. CPC F03B 13/10
USPC 290/54

(57) ABSTRACT

Energy recovery arrangements are described for evaporative cooling systems in which cooling water undergoes a pressure transition from a pressurized state to a pressure-reduced state at one or more pressure transition locations in the cooling system, with an energy recovery water turbine being positioned at at least one of the pressure transition locations to receive pressurized water for flow therethrough to generate an energy output. The energy output may be utilized to reduce cooling utility requirements for an installation in which the evaporative cooling system is installed and/or the recovered energy may be exported to an electrical grid or other use facility.

### FIELD OF THE INVENTION

The present invention relates to evaporative cooling systems adapted for energy recovery during their operation.

### DESCRIPTION OF THE RELATED ART

A cooling tower is a heat rejection device, which extracts waste heat to the atmosphere though the cooling of a water stream to a lower temperature. The type of heat rejection in a cooling tower is termed “evaporative” in that it allows a small portion of the water stream that is being cooled to evaporate into a moving air stream to thereby provide significant cooling to the remainder of that water stream. The heat from the water stream that is transferred to the air stream raises the air's temperature and its relative humidity to 100%, and this air is discharged to the atmosphere. Evaporative heat rejection devices such as cooling towers are commonly used to provide significantly lower water temperatures than are achievable with “air cooled” or “dry” heat rejection devices such as vehicle radiators, thereby realizing more cost-effective and energy-efficient cooling operation.

Evaporative coolings systems utilizing cooling towers are conventionally employed in many industrial installations, office buildings, residential high-rise buildings, and the like. The cooling tower of such cooling systems is typically roof-mounted, with the water circulation being effected by flow circuitry containing pumps, compressors, and valving components, for maintaining a flow of the water in the system at a desired volumetric flow rate that will satisfy the cooling needs of the installation in which the system is deployed.

The energy requirements of evaporative cooling systems are substantial, particularly when the facility being cooled is a tall structure such as a multi-story building. It is desirable to minimize the amount of net energy that is required for the operation of the evaporative cooling system, and to otherwise render such systems as energy efficient as possible.

### SUMMARY

The present disclosure relates to evaporative cooling systems adapted for energy recovery.

In one aspect, the disclosure relates to an evaporative cooling system, comprising a cooling tower coupled with a water flow circuit to which a pump and heat exchanger are operatively coupled, configured so that water warmed by heat exchange in the heat exchanger is driven by the pump to the cooling tower for evaporative cooling, with recirculation of cooled water from the cooling tower to the heat exchanger. In such system, water in the water flow circuit, and water in a make-up water feed to the cooling tower, undergo a pressure transition from a pressurized state to a pressure-reduced state at one or more pressure transition locations in the cooling system, and an energy recovery water turbine is positioned at at least one of the pressure transition locations to receive pressurized water for flow therethrough to generate an energy output.

In another aspect, the disclosure relates to an evaporatively cooled installation, comprising a building and an evaporative cooling system of the present disclosure, operatively arranged to provide cooling of at least one of air and water for the building

In a further aspect, the disclosure relates to a method of reducing cooling cost of an installation comprising an evaporative cooling system in which water undergoes a pressure transition from a pressurized state to a pressure-reduced state, said method comprising flowing water at the pressurized state to an energy recovery water turbine at a locus of said pressure transition to recover an energy output.

Other aspects, features and embodiments of the disclosure will be more fully apparent from the ensuing description and appended claims.

### BRIEF DESCRIPTION OF THE DRAWINGS

FIG. 1 is a schematic representation of an evaporative cooling system of the present disclosure, as deployed for cooling of a building.

### DETAILED DESCRIPTION

The present disclosure relates to evaporative cooling systems in which pressurized-to-lower-pressure transitions are utilized to recover energy.

Evaporative cooling systems of the present disclosure utilize water flow turbines, e.g., at one or more of such pressurized-to-atmospheric pressure transition locations in the water flow circuitry, to recover energy from the water stream, which then can be utilized in the installation in which the cooling system is deployed, or alternatively exported for use to an electrical grid or other usage.

The energy recovery water turbine(s) in the evaporative cooling system configured according to the present disclosure, are placed at one or more locations in the cooling system at which the water flows from a pressurized (e.g., superatmospheric pressure) zone to a non-pressurized (e.g., atmospheric pressure) or lower-pressurized zone. For example, an energy recovery water turbine can be placed in the cooling loop at a location of pressure-dissipating discharge from a pipe, or other location receiving water discharged from a water column fed by free-falling water in the cooling loop, which can further take advantage of the hydrodynamic head resulting from gravity flow of water from a cooling tower, e.g., on the roof of a building or on a dedicated utilities structure, to a lower level where re-pressurization pump(s) are located in proximity to heat exchanger(s) in the cooling loop. A cooling loop as referred to herein comprises an evaporative cooling tower, heat exchangers (or chillers), and associated flow circuitry, valves, and pumps (motive fluid drivers).

The energy recovery water turbine(s) usefully employed in the evaporative cooling systems of the present disclosure can be of any suitable type, and may be specifically optimized for use in the specific evaporative cooling system in which it is deployed. For example, “impulse” as well as “reaction” energy recovery water turbines may be employed, among other types of energy recovery turbines.

Impulse turbines generally use velocity of a water stream to translate a runner element, and discharges to atmospheric (ambient) pressure. In operation, the water stream impinges on each bucket on the runner. There is no section on the downside of such turbine, and water flows out of the bottom of the turbine housing after impingement on the runner. Impulse turbines are generally suitable for high dynamic head, low flow applications.

Reaction turbines develop power from the combined action of pressure and moving water. The runner element is placed directly in a water stream flowing over the blades rather than striking each individually. Reaction turbines generally are used at sites with lower dynamic head and higher flows than are utilized in the case of impulse turbines.

The present disclosure in various embodiments contemplates an evaporative cooling system, comprising a cooling tower coupled with a water flow circuit to which a pump and heat exchanger are operatively coupled, configured so that water warmed by heat exchange in the heat exchanger is driven by the pump to the cooling tower for evaporative cooling, with recirculation of cooled water from the cooling tower to the heat exchanger. In such system, water in the water flow circuit, and water in a make-up water feed to the cooling tower, undergo a pressure transition from a pressurized state to a pressure-reduced state at one or more pressure transition locations in the cooling system, and an energy recovery water turbine is positioned at at least one of the pressure transition locations to receive pressurized water for flow therethrough to generate an energy output.

In such evaporative cooling system, the cooling tower may be positioned at an elevation above the location of the pump and heat exchanger so that the pump drives water to the cooling tower against a hydrostatic/hydrodynamic head of water in the water flow circuit. The energy output of the energy recovery water turbine in the evaporative cooling system may comprise electrical energy involving hydroelectric conversion by the water turbine, e.g., a turboelectric energy recovery water turbine.

The evaporative cooling system may comprise multiple pressure transition locations in the cooling system. In such a system, an energy recovery water turbine can be deployed at two or more of the multiple pressure transition locations in the cooling system. As discussed more fully hereinafter, the one or more pressure transition locations in the cooling system at which an energy recovery water turbine can be positioned, may include one or more of:

(i) a lower portion of the water flow circuit having the energy recovery water turbine coupled thereto so that the energy recovery water turbine receives water from an upwardly extending column of water deriving from the cooling tower;
(ii) a lower portion of a waste blow-down line having the energy recovery water turbine coupled thereto so that the energy recovery water turbine receives water from an upwardly extending column of water deriving from the cooling tower;
(iii) a discharge location of the water flow circuit at which pressurized water is discharged to the cooling tower, wherein the energy recovery water turbine is arranged to received the discharged pressurized water; and
(iv) a discharge location in the make-up water feed to the cooling tower at which pressurized make-up water is discharged to the cooling tower, wherein the energy recovery water turbine is arranged to received the discharged pressurized water.

Each of these locations may have an energy recovery water turbine positioned at the specific pressure transition locus to recover energy, or a specific one or ones of the pressure transition loci may be configured to utilize an energy recovery water turbine for energy recovery in the operation of the evaporative cooling system.

Thus, in a specific embodiment, the evaporative cooling system may be configured with an energy recovery water turbine positioned at a lower portion of the water flow circuit having the energy recovery water turbine coupled thereto so that the energy recovery water turbine receives water from an upwardly extending column of water deriving from the cooling tower.

In another embodiment, the evaporative cooling system may be configured with an energy recovery water turbine positioned at a lower portion of a waste blow-down line having the energy recovery water turbine coupled thereto so that the energy recovery water turbine receives water from an upwardly extending column of water deriving from the cooling tower.

A further embodiment of the evaporative cooling system comprises an energy recovery water turbine positioned at a discharge location of the water flow circuit at which pressurized water is discharged to the cooling tower, wherein the energy recovery water turbine is arranged to received the discharged pressurized water.

In yet another embodiment, the evaporative cooling system is configured with an energy recovery water turbine positioned at a discharge location in the make-up water feed to the cooling tower at which pressurized make-up water is discharged to the cooling tower, wherein the energy recovery water turbine is arranged to received the discharged pressurized water.

In specific embodiments of the present disclosure, the pressure-reduced state at one or more pressure transition locations in the cooling system comprises an atmospheric pressure state.

The evaporative cooling system of the present disclosure may be installed at a building, with the cooling tower positioned on a roof of the building. In such configuration, the pump and heat exchanger may be located in a lower portion of the building, e.g., in a sub-surface portion of the building. The building may be a low-rise building, or a high-rise building, e.g., a multi-story building.

The evaporative cooling system may be arranged to provide recovered energy from the energy recovery water turbine to the building or its environs, and/or configured to provide recovered energy from the energy recovery water turbine to an electrical grid.

As discussed hereinabove, the energy recovery water turbine may be of any suitable type, and may for example comprise an impulse-type energy recovery water turbine, or a reaction-type energy recovery water turbine. The energy recovery water turbine may be a turboelectric energy recovery water turbine. In specific embodiments, the water flow circuit of the evaporative cooling system may comprise a high head water flow circuit.

The disclosure thus contemplates an evaporatively cooled installation, comprising a building and an evaporative cooling system of a type as variously described herein, operatively arranged to provide cooling of at least one of air and water for the building.

The disclosure further contemplates a method of reducing cooling cost of an installation comprising an evaporative cooling system in which water undergoes a pressure transition from a pressurized state to a pressure-reduced state, such method comprising flowing water at the pressurized state to an energy recovery water turbine at a locus of the pressure transition to recover an energy output. In such method, the energy recovery water turbine may comprise an impulse-type energy recovery water turbine, a reaction-type energy recovery water turbine, a turboelectric energy recovery water turbine, or other water turbine that is configured to recover energy, e.g., electrical energy, at a pressure transition locus in the evaporative cooling system.

The evaporative cooling system in such method may comprise multiple ones of pressure transition from a pressurized state to a pressure-reduced state. The method may therefore involve flowing water at the pressurized state to an energy recovery water turbine at two or more pressure transition loci in the evaporative cooling system.

The method above described may be carried out with an evaporative cooling system that is installed at a building, and operatively arranged to provide cooling of at least one of air and water for the building. The method may involve further utilization of the recovered energy, e.g., for reducing energy costs of an installation in which the evaporative cooling system is installed, and/or exporting the recovered energy to an energy grid.

The evaporative cooling systems of the present disclosure achieve recovery of energy using water flow turbines to capture energy that is otherwise lost in the normal evaporative cooling process in the flows of water that are employed in such systems. In a typical evaporative cooling system, the operating parameters and water flows are subject to the general requirement that for every ton of cooling capacity, water must recirculate within the cooling loop at a volumetric flow of approximately 3 gallons per minute, achieving a ΔT of ˜10° F. given 6 cycles of concentration. As an example, a 10,000 ton evaporative cooling tower will recirculate water at the rate of 30,000 gpm. This is a significant recirculating flow of water, which requires a significant amount of electrical pumping power for its movement in the cooling loop. By capturing such “otherwise lost” energy using energy recovery water turbines at one or more locations in the cooling loop at which water is released from a pressurized zone to a non-pressurized or lower-pressurized zone, the evaporative cooling system of the present disclosure can significantly reduce the carbon footprint and total energy required to operate such an evaporative cooling system.

The implementation of the evaporative cooling system of the present disclosure requires an initial assessment of the amount of available “hydro” power. Two vital factors for this consideration are the volumetric flow and the hydrodynamic/hydrostatic head of the water stream in the cooling loop. The volumetric flow is the volume of water that can be captured and an employed to turn the energy recovery turbine generator, and the head is the distance that water in the cooling loop will fall, or flow from a pressurized pipe, on its way to the generator. The larger the volumetric flow, the larger the quantity of water, and the higher the head i.e., the greater the pressurized flow or higher the distance through which the water falls, the more energy is available for conversion to electricity. A twofold increase in the volumetric flow will double the power that is available for recovery, and a further twofold increase in the head will likewise double the power that is available for recovery.

A “low head” site typically has a head below about 10 m in height. In such instance, a substantial volumetric flow of water is necessary to generate significant electricity via energy recovery. A “high head” site typically has a head exceeding about 20 m in height, and in such case, a relatively lower volumetric flow of water can be accommodated in relation to the potential energy associated with the gravitational effect on a tall column of water. The general equation governing power associated with the water flow stream is:

Power=Head×Flow×Gravity

where Power is measured in watts, Head is measured in meters, Flow is measured in liters per second, and Gravity is gravitational acceleration measured in meters per second per second, and is approximately 9.81 msec/sec, i.e., each second in which an object is falling, its speed increases by 9.81 m/second, until it reaches its terminal velocity. As an illustrative example, an evaporative cooling system may have a volumetric flow of 20 liters per second with a head of 12 meters, so that the hydro power available from the recirculating water stream is 12×20×9.81=2,354 Watts.

Referring now to the drawing, FIG. 1 is a schematic representation of an evaporative cooling system 10 of the present disclosure, as deployed for cooling of a multistory building B.

The evaporative cooling system 10 includes a cooling tower 12 reposed on the roof of building B, in which the cooling tower is arranged to receive water from a recirculation flow circuit 14 comprising suitable piping, pipe couplings, and other suitable elements of conventional flow circuitry. The recirculation flow circuit 14 comprises a pump 18 and a heat exchanger 20. A blow-down line 24 is provided, coupled to the sump of the cooling tower 12 and discharging into a waste blowdown drain (not shown).

The hydrostatic head of water associated with the recirculation water in the sump of the cooling tower 12, h1, and the additional hydrostatic head, h2, associated with the flow circuit piping to the pressurized-to-atmospheric pressure discharge location, provide an overall hydrostatic head, h1+h2, that along with the dynamic pressure drops associated with the piping and flow circuit components (heat exchanger, valves, etc.) must be accommodated by the pump 18 in the flow circuit. Such pump may be of any suitable size and type, as a motive fluid driver for the flow circuit, and may for example have an efficiency on the order of 80-85%.

The building B in an illustrative embodiment comprises a 48-floor multistory building with the aforementioned roof-mounted cooling tower and associated water turbines, piping runs, and basement equipment including heat exchangers, pumps, etc. It will be recognized that the cooling system is shown in a simplified schematic manner, and may in practice comprise redundant flow circuitry components, bypass loops, and other flow circuitry arrangements and variations.

In the FIG. 1 system, there are at least four (4) potential sites for installation of energy recovery water turbines, taking advantage of where water is discharged from a pressurized zone to an atmospheric zone: Site 1: at the bottom of the 48-floor drop in the recirculating loop from the rooftop cooling tower 12 to the basement heat exchanger 20, where an energy recovery water turbine 16 is disposed; Site 2: at the bottom of the 48-floor drop in the waste blow-down line 24 from the rooftop sump of the cooling tower 12, where energy recovery water turbine 26 is disposed; Site 3: at the discharge from pressurized to atmospheric pressure zone at the top of the evaporative cooling tower 12 on the rooftop of the building B, where energy recovery water turbine 22 is disposed; Site 4: at the discharge from pressurized to atmospheric pressure zone at the top of the evaporative cooling tower 12 on the rooftop of the building B where make-up water is fed into the water recirculation flow circuit 14 to off-set evaporation and drift water loss, in makeup water feed line 28, in which energy recovery water turbine 28 is disposed.

The advantages and features of the evaporative cooling system of the present disclosure are further illustrated with reference to the following example, which is not to be construed as in any way limiting the scope of the disclosure but rather as illustrative of one embodiment of the disclosure in a particular application thereof.

### Example 1

An evaporative cooling system of the type shown in FIG. 1, comprising a single energy recovery water turbine 16 at Site 1, is provided in a 48-floor office building similar in height and design to the Duke Energy Center building located in uptown Charlotte, N.C. The 48-floor cooling tower provides approximately 3000 tons of cooling capacity with a water recirculation rate of 9000 gallons per minute (GPM). The hydrostatic head (h1+h2) is 146 meters. The flow rate of water in the system is 2,043,900 liters/second.

The “hydro power” of this cooling system is 2,927,396,214 Watts, and with an energy recovery water turbine achieving 60% system efficiency, the energy recovered by the energy recovery water turbine is 1,756,437,728 Watts of generated electricity.

Such level of energy recovery deriving from a pressurized-to-atmospheric-pressure location in the water recirculation flow circuit of the evaporative cooling system can be utilized to achieve a substantial reduction in the net energy requirements of the installation in which the evaporative cooling system of the present disclosure is deployed, if such recovered energy is used to satisfy the energy requirements of the installation. Alternatively, the recovered electrical energy can be exported to an electrical grid to generate operating revenue for the installation, or it can be provided to exterior electrically powered systems and subsystems on the building site, such as exterior lighting, walkway de-icing systems, electric vehicle charging stations, signage, etc.

It therefore is evident that the evaporative cooling system of the present disclosure, utilizing energy recovery water turbine(s), provides an effective approach to energy conservation and facilities management in installations serviced by such cooling systems wherein substantial energy is present in cooling water streams that undergo pressurized-to-atmospheric-pressure transitions in the associated flow circuitry.

While the disclosure has been set forth herein in reference to specific aspects, features and illustrative embodiments, it will be appreciated that the utility of the disclosure is not thus limited, but rather extends to and encompasses numerous other variations, modifications and alternative embodiments, as will suggest themselves to those of ordinary skill in the field of the present disclosure, based on the description herein. Correspondingly, the invention as hereinafter claimed is intended to be broadly construed and interpreted, as including all such variations, modifications and alternative embodiments, within its spirit and scope.

What is claimed is:

1. An evaporative cooling system, comprising a cooling tower coupled with a water flow circuit to which a pump and heat exchanger are operatively coupled, configured so that water warmed by heat exchange in the heat exchanger is driven by the pump to the cooling tower for evaporative cooling, with recirculation of cooled water from the cooling tower to the heat exchanger, wherein water in the water flow circuit, and water in a make-up water feed to the cooling tower, undergo a pressure transition from a pressurized state to a pressure-reduced state at one or more pressure transition locations in the cooling system, and an energy recovery water turbine positioned at at least one of said pressure transition locations to receive pressurized water for flow therethrough to generate an energy output.

2. The evaporative cooling system of claim 1, wherein the cooling tower is positioned at an elevation above the location of the pump and heat exchanger so that the pump drives water to the cooling tower against a hydrostatic/hydrodynamic head of water in the water flow circuit.

3. The evaporative cooling system of claim 1, wherein the energy output comprises electrical energy.

4. The evaporative cooling system of claim 1, comprising multiple pressure transition locations in the cooling system.

5. The evaporative cooling system of claim 1, comprising a said energy recovery water turbine at at two or more of the multiple pressure transition locations in the cooling system.

6. The evaporative cooling system of claim 1, wherein the one or more pressure transition locations at which a said energy recovery water turbine is positioned comprises one or more of:
(i) a lower portion of the water flow circuit having the energy recovery water turbine coupled thereto so that the energy recovery water turbine receives water from an upwardly extending column of water deriving from the cooling tower;
(ii) a lower portion of a waste blow-down line having the energy recovery water turbine coupled thereto so that the energy recovery water turbine receives water from an upwardly extending column of water deriving from the cooling tower;
(iii) a discharge location of the water flow circuit at which pressurized water is discharged to the cooling tower, wherein the energy recovery water turbine is arranged to received the discharged pressurized water; and
(iv) a discharge location in the make-up water feed to the cooling tower at which pressurized make-up water is discharged to the cooling tower, wherein the energy recovery water turbine is arranged to received the discharged pressurized water.

7. The evaporative cooling system of claim 1, comprising a said energy recovery water turbine positioned at a lower portion of the water flow circuit having the energy recovery water turbine coupled thereto so that the energy recovery water turbine receives water from an upwardly extending column of water deriving from the cooling tower.

8. The evaporative cooling system of claim 1, comprising a said energy recovery water turbine positioned at a lower portion of a waste blow-down line having the energy recovery water turbine coupled thereto so that the energy recovery water turbine receives water from an upwardly extending column of water deriving from the cooling tower.

9. The evaporative cooling system of claim 1, comprising a said energy recovery water turbine positioned at a discharge location of the water flow circuit at which pressurized water is discharged to the cooling tower, wherein the energy recovery water turbine is arranged to receive the discharged pressurized water.

10. The evaporative cooling system of claim 1, comprising a said energy recovery water turbine positioned at a discharge location in the make-up water feed to the cooling tower at which pressurized make-up water is discharged to the cooling tower, wherein the energy recovery water turbine is arranged to receive the discharged pressurized water.

11. The evaporative cooling system of claim 1, wherein said pressure-reduced state at one or more pressure transition locations in the cooling system comprises an atmospheric pressure state.

12. The evaporative cooling system of claim 1, as installed at a building, with the cooling tower positioned on a roof of the building.

13. The evaporative cooling system of claim 12, wherein the pump and heat exchanger are located in a lower portion of the building.

14. The evaporative cooling system of claim 12, wherein the pump and heat exchanger are located in a sub-surface portion of the building.

15. The evaporative cooling system of claim 12, as arranged to provide recovered energy from the energy recovery water turbine to the building or its environs.

16. The evaporative cooling system of claim 1, as configured to provide recovered energy from the energy recovery water turbine to an electrical grid.

17. The evaporative cooling system of claim 1, wherein the energy recovery water turbine comprises an impulse-type energy recovery water turbine.

18. The evaporative cooling system of claim 1, wherein the energy recovery water turbine comprises a reaction-type energy recovery water turbine.

19. The evaporative cooling system of claim 1, wherein the energy recovery water turbine comprises a turboelectric energy recovery water turbine.

20. The evaporative cooling system of claim 1, wherein the water flow circuit comprises a high head water flow circuit.

21. An evaporatively cooled installation, comprising a building and an evaporative cooling system according to claim 1, operatively arranged to provide cooling of at least one of air and water for the building.

22. A method of reducing cooling cost of an installation comprising an evaporative cooling system in which water undergoes a pressure transition from a pressurized state to a pressure-reduced state, said method comprising flowing water at the pressurized state to an energy recovery water turbine at a locus of said pressure transition to recover an energy output.

23. The method of claim 22, wherein the energy recovery water turbine comprises an impulse-type energy recovery water turbine.

24. The method of claim 22, wherein the energy recovery water turbine comprises a reaction-type energy recovery water turbine.

25. The method of claim 22, wherein the energy recovery water turbine comprises a turboelectric energy recovery water turbine.

26. The method of claim 22, wherein the energy output comprises electrical energy.

27. The method of claim 22, wherein the evaporative cooling system comprises multiple ones of pressure transition from a pressurized state to a pressure-reduced state.

28. The method of claim 27, wherein water at the pressurized state is flowed to a said energy recovery water turbine at two or more pressure transition loci in the evaporative cooling system.

29. The method of claim 22, wherein the evaporative cooling system is installed at a building, and operatively arranged to provide cooling of at least one of air and water for the building.

30. The method of claim 22, further comprising utilizing the recovered energy.

31. The method of claim 30, wherein the recovered energy is utilized for reducing energy costs of an installation in which the evaporative cooling system is installed.

32. The method of claim 30, wherein the recovered energy is exported to an energy grid.
